(19) United States
(12) Patent Application Publication
(10) Pub. No.: US 2024/0316372 A1
(43) Pub. Date: Sep. 26, 2024

(54) RESPIRATORY PROTECTION DEVICES

(71) Applicant: OpenAeros LLC, St. Paul, MN (US)

(72) Inventors: Aaron Michael Collins, Minneapolis, MN (US); Chia Hua M. Pang, St. Paul, MN (US); Rachel Andreasen, St. Paul, MN (US); Christopher Richard Saline Libby, St. Louis Park, MN (US)

(21) Appl. No.: 18/603,995

(22) Filed: Mar. 13, 2024

Related U.S. Application Data
(60) Provisional application No. 63/454,220, filed on Mar. 23, 2023.

(51) Int. Cl. A62B 23/02; B01D 46/52

(52) U.S. Cl. CPC A62B 23/025; B01D 46/521; B01D 2279/40

(57) ABSTRACT

A respiratory protection device can be used to cover a portion of a face of a human user including the mouth or the nostrils of the user, or both. The device can include a shell and inserts embedded therein. The inserts can be formed of a thermoformable material embedded in the shell. The inserts are capable of being heated to a moldable temperature of the thermoformable material and form-fitted to a portion of the face of the user such that the shell creates a seal around at least the mouth or the nostrils of the user. Also, the thermoformable material can be moldable at a temperature safe to contact skin of the user such as by having a Young's modulus from a range of 0.03 GPa to 1 GPa at temperatures of less than 30° C. Also, the device can include a filter medium attached to the shell.

### CROSS-REFERENCE TO RELATED APPLICATIONS

The present application claims priority to Prov. U.S. Pat. App. Ser. No. 63/454,220, filed Mar. 23, 2023, the entire disclosure of which application is hereby incorporated herein by reference.

### FIELD

The present disclosure relates generally to personal protection equipment. More specifically, the disclosure relates to respiratory protection devices.

### BACKGROUND

Respiratory protection devices are essential to help reduce the spread of infectious diseases, such as respiratory illnesses like COVID-19, influenza, tuberculosis, etc. When an infected person talks, coughs, or sneezes, respiratory aerosols containing the virus can be expelled into the air and potentially infect others. Respiratory protection devices help provide a physical barrier to prevent these respiratory aerosols from spreading, and can also protect the wearer from inhaling respiratory aerosols from others who can be infected. Additionally, these devices can also help protect individuals with weakened immune systems or underlying health conditions that make them more susceptible to severe illness or complications from an infection. Advances can be made in devices that create a better seal around a user's face, especially while talking or moving, while also providing improved breathability.

### SUMMARY

The present disclosure relates to respiratory protection devices. The respiratory protection devices can include a shell having one or more inserts embedded into the shell. The one or more inserts can include a thermoformable material. The respiratory protection device is usable to cover at least a portion of the face of a user (such as the mouth and nostrils of a user). In some embodiments, the one or more inserts are capable of being heated to a moldable temperature of the thermoformable material. Also, the one or more inserts can be form-fitted to at least a portion of the face of the user such that the shell creates a seal around the portion of the face (such as a seal around the mouth or the nostrils of a user, or a combination thereof).

In some embodiments, a respiratory protection device includes a shell shaped to cover at least a portion of a face of a user (such as to cover the mouth or the nostrils of a user, or a combination thereof), and one or more inserts are embedded in a first side of the shell. In some embodiments, the one or more inserts include or are formed of a thermoformable material. In some embodiments, the thermoformable material is moldable at a temperature safe to contact the skin of the user.

In some embodiments, the shell is made of a rigid or semi-rigid material. In some embodiments, the rigid material includes plastics including acrylonitrile butadiene styrene, nylon, polycarbonate, polyethylene, polypropylene, or a combination thereof. In some embodiments, the semi-rigid material includes silicone, polyurethane, or a combination thereof. In some embodiments, the one or more inserts are capable of being heated to a moldable temperature of the thermoformable material. In some embodiments, the one or more inserts are form-fitted to at least a portion of the face such that the shell creates a seal around the portion of the face (such as a seal around the mouth or the nostrils of a user, or a combination thereof).

In some embodiments, the thermoformable material includes a thermoplastic polymer selected from a group consisting of polypropylene (PP), thermoplastic polyurethane (TPU), polycaprolactone (PCL), ethylene-vinyl acetate (EVA), polypropylene carbonate (PPC), poly(tetramethylene oxide) (PTMO), poly(ethylene adipate) (PEA), poly(ethylene oxide) (PEO), polyethylene glycol (PEG), poly(tetramethylene oxide) (PTMO), a copolymer thereof, or a combination thereof. In some embodiments, the thermoformable material is moldable at a temperature from a range of 30° C. to 70° C. In some embodiments, the thermoformable material includes low-temperature thermoplastics selected from a group consisting of polycaprolactone (PCL), ethylene-vinyl acetate (EVA), thermoplastic polyurethane (TPU), or a combination thereof.

In some embodiments, wherein the face of the user includes a nose and a mouth, the respiratory protection device includes a first portion configured to cover the nose, and a second portion configured to cover the mouth. In some embodiments, the first portion has a first width, and the second portion has a second width. In some embodiments, the first width is same as the second width. In some embodiments, the first width is smaller than the second width. In some embodiments, the one or more inserts include one or more first inserts, and each of the one or more first inserts is embedded in both the first and the second portion of the shell. In some embodiments, the one or more first inserts have a thickness from a range of 0.6 mm to 8 mm. In some embodiments, the one or more inserts include a second insert embedded in only the second portion of the shell. In some embodiments, the second insert has a thickness from a range of 0.1 mm to 3 mm. In some embodiments, the one or more first inserts and the second insert are connected or abutting. In some embodiments, the one or more first inserts is spaced apart from the second insert at a distance from a range of 1 mm to 35 mm. In some embodiments, the shell further includes a metal wire embedded in the first portion. In some embodiments, the metal wire includes aluminum, titanium, silver, nickel, or any alloy thereof, or any combination thereof.

In some embodiments, the shell has a groove formed on a second side of the shell that is opposite of the first side of the shell in that the first and second sides are facing in opposite directions. In some embodiments, the respiratory protection device includes a filter medium. The filter medium can include a filter material. Also, the filter medium can include a rigid edge defining a perimeter around the filter material. In some embodiments, the rigid edge is configured to be inserted into the groove on the second side of the shell. In some embodiments, the filter medium is configured to be compliant to allow movements of the user's face. In some cases, the movements of the user's face includes jaw motions. In some embodiments, the filter medium includes an elastomeric material. In some embodiments, the elastomeric material is natural rubber, polyurethane, polybutadiene, neoprene, silicone, or a combination thereof. In some embodiments, the filter medium includes a pleated surface including a plurality of horizontal pleats. In some embodiments, the filter medium includes a pleated surface including a plurality of vertical pleats.

In some embodiments, the respiratory protection device includes a respirator. In some cases, the user is a human using the respirator or the respiratory protection device.

In some embodiments, the thermoformable material has a Young's modulus from a range of 0.03 GPa to 1 GPa at temperatures of less than 30° C.

In some embodiments, a respiratory protection device includes a shell shaped to cover at least a portion of a face of a user (such as a cover the mouth or the nostrils of a user, or a combination thereof), one or more inserts embedded in a first side of the shell, and a filter medium including or formed of a foldable laminated material. In some embodiments, the one or more inserts include or are formed of a thermoformable material. In some embodiments, the thermoformable material is moldable at a temperature safe to contact the skin of the user. In some embodiments, the foldable laminated material includes a filter material including polypropylene, polyester, glass microfibers, cellulose, or a combination thereof. In some embodiments, the foldable laminated material includes a semi-rigid support material including silicone, polypropylene, polyester, polyurethane or a combination thereof.

These and other important aspects of the invention are described more fully in the detailed description below. The invention is not limited to the particular apparatuses and systems described herein. Other embodiments can be used and changes to the described embodiments can be made without departing from the scope of the claims that follow the detailed description. Within the scope of this application, it should be understood that the various aspects, embodiments, examples, and alternatives set out herein, and individual features thereof can be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 illustrates a perspective view of an example respiratory protection device, in accordance with some embodiments of the present disclosure.

FIGS. 2 to 4 illustrate different parts of an example respiratory protection device, such as the device shown in FIG. 1, in accordance with some embodiments of the present disclosure.

FIG. 5 illustrates is a cross-sectional view of an example respiratory protection device, such as the device shown in FIG. 1, in accordance with some embodiments of the present disclosure.

FIG. 6 illustrates a cross-sectional view of an example respiratory protection device having a filter medium, in accordance with some embodiments of the present disclosure.

FIG. 7 illustrates a perspective view of an example filter medium, such as for the device shown in FIG. 6, in accordance with an embodiment of the present disclosure.

### DETAILED DESCRIPTION OF THE DRAWINGS

Details of example embodiments of the invention are described in the following detailed description with reference to the drawings. Although the detailed description provides reference to example embodiments, it is to be understood that the invention disclosed herein is not limited to such example embodiments. But to the contrary, the invention disclosed herein includes numerous alternatives, modifications, and equivalents as will become apparent from consideration of the following detailed description and other parts of this disclosure.

The present application discloses example respiratory protection devices that can include a shell having one or more inserts embedded in the shell, and in some cases, the one or more inserts include or are formed of a thermoformable material. The respiratory protection device is usable to cover at least a portion of the face of a user, such as cover the mouth or the external nares of a user, or a combination thereof. For the purposes of this disclosure, the terms “external nares” and “nostrils” are used herein to mean the same thing and are interchangeable.

In some embodiments, the one or more inserts are embedded in a first side of the shell. In some embodiments, the one or more inserts are capable of being heated to a moldable temperature of the thermoformable material, and, in some examples, the insert(s) are form-fitted to at least a portion of the face such that the shell creates a seal around the portion of the face of the user (such as a seal around the mouth or the external nares of a user, or a combination thereof).

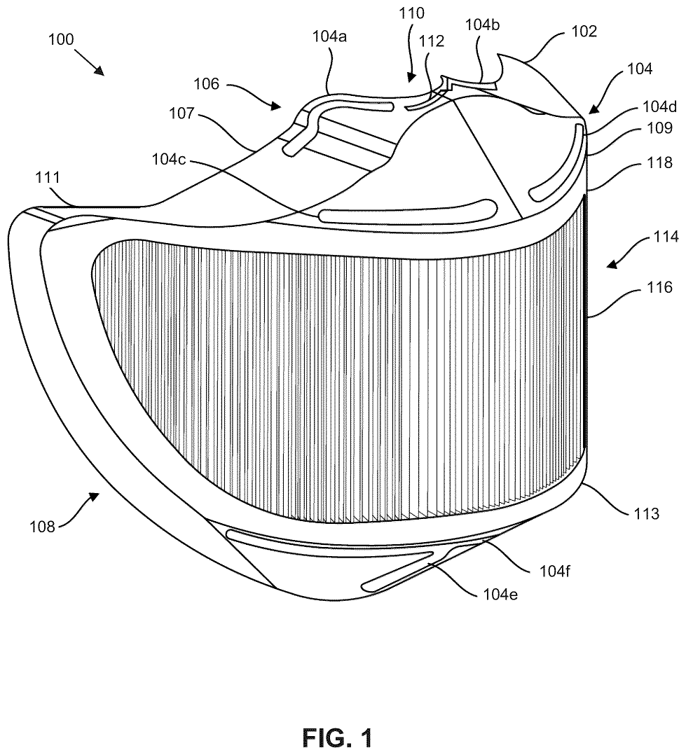

FIG. 1 illustrates a perspective view of an example respiratory protection device 100, in accordance with some embodiments of the present disclosure. As shown, the respiratory protection device 100 (which can be, be a part of, or include a respirator) includes a shell 102 shaped to cover at least a portion of a face of a user (such as to cover the mouth or the external nares of a human user, or a combination thereof) and one or more inserts 104 embedded in the shell 102. In some embodiments, the one or more inserts 104 include or are formed of a thermoformable material moldable at a temperature safe to contact a skin of the user.

In some embodiments, the shell 102 is made of a rigid or semi-rigid material. The rigid material can include plastics such as acrylonitrile butadiene, styrene, nylon, polycarbonate, polyethylene, polypropylene, or a combination thereof. The semi-rigid material can include silicone or polyurethane materials. In some embodiments, the shell 102 includes a rigid material having a Shore D hardness from a range of 70 to 100. In some embodiments, the shell 102 includes a semi-rigid material having a Shore D hardness from a range of 40 to 60.

In some embodiments, the one or more inserts 104 are capable of being heated to a moldable temperature of the thermoformable material. In some embodiments, the one or more inserts 104 are form-fitted to at least a portion of the face such that the shell creates a seal around the portion of the face of the user (such as a seal around the mouth or the external nares of a human user, or a combination thereof). The thermoformable material can include a thermoplastic polymer, for example, polypropylene (PP), thermoplastic polyurethane (TPU), polycaprolactone (PCL), ethylene-vinyl acetate (EVA), polypropylene carbonate (PPC), poly(tetramethylene oxide) (PTMO), poly(ethylene adipate) (PEA), poly(ethylene oxide) (PEO), polyethylene glycol (PEG), poly(tetramethylene oxide) (PTMO), a copolymer thereof, or a combination thereof.

In some embodiments, the thermoformable material is moldable at a temperature from a range of 30° C. to 70° C., or 30° C. to 65° C., or 30° C. to 60° C., or 30° C. to 55° C., or 30° C. to 50° C., or 30° C. to 45° C., or 30° C. to 40° C., or 30° C. to 35° C., or can be moldable at a temperature encompassed within these ranges.

In some embodiments, the thermoformable material is moldable at a temperature from a range of 30° C. to 70° C., or 35° C. to 70° C., or 40° C. to 70° C., or 45° C. to 70° C., or 50° C. to 70° C., or 55° C. to 70° C., or 60° C. to 70° C., or 65° C. to 70° C., or can be moldable at a temperature encompassed within these ranges.

In some embodiments, the thermoformable material includes low-temperature thermoplastics, for example, polycaprolactone or ethylene-vinyl acetate (EVA). In some embodiments, the thermoformable material has a Young's modulus from a range of 0.03 GPa to 1 GPa, or 0.04 GPa to 1 GPa, or 0.05 GPa to 1 GPa, or 0.06 GPa to 1 GPa, or 0.07 GPa to 1 GPa, or 0.08 GPa to 1 GPa, or 0.09 GPa to 1 GPa, or 0.1 GPa to 1 GPa, or 0.2 GPa to 1 GPa, or 0.3 GPa to 1 GPa, or 0.4 GPa to 1 GPa, or 0.5 GPa to 1 GPa, or 0.6 GPa to 1 GPa, or 0.7 GPa to 1 GPa, or 0.8 GPa to 1 GPa, or 0.9 GPa to 1 GPa at temperatures of less than 30° C., or can have a Young's modulus at a temperature less than 30° C. encompassed within these ranges.

In some embodiments, the thermoformable material has a Young's modulus from a range of 0.03 GPa to 0.9 GPa, or 0.03 GPa to 0.8 GPa, or 0.03 GPa to 0.7 GPa, or 0.03 GPa to 0.6 GPa, or 0.03 GPa to 0.5 GPa, or 0.03 GPa to 0.4 GPa, or 0.03 GPa to 0.3 GPa, or 0.03 GPa to 0.2 GPa, or 0.03 GPa to 0.1 GPa at temperatures of less than 30° C., or can have a Young's modulus at a temperature less than 30° C. encompassed within these ranges.

In some embodiments, the user's face includes a nose and a mouth, and the respiratory protection device 100 can include a first portion 106 configured to cover the nose of the user (or at least the external nares of a human user), and a second portion 108 configured to cover the mouth of the user. In some embodiments, for example as shown in FIG. 1, the first portion 106 includes a groove 110 at a first edge 107 (e.g., user-contacting edge) of the first portion 106, and first inserts 104a and 104b on each side of the groove 110. In some embodiments, the insert 104a and insert 104b can be separate pieces embedded in the shell 102 on each side of the groove 110. In some embodiments, the inserts 104a and 104b are embedded near the edge of the shell 102 and follows the general contour of the shell 102 around the groove 110.

The first portion 106 can further include first inserts 104c and 104d at a second edge 109 of the first portion 106 opposite of the first edge 107 of the first portion 106. The second edge 109 of the first portion 106 can contact a first edge 111 of the second portion 108 of the respiratory protection device 100. In some embodiments, the first portion 106 and the second portion 108 are separate pieces connected via an adhesive at the second edge 109 of the first portion 106 and the first edge 111 of the second portion 108. In some embodiments, the first portion 106 and second portion 108 are formed as one unified piece. The first inserts 104c and 104d can be separate pieces or can be connected or abutting. In some embodiments, the first inserts 104c and 104d are embedded in the shell 102 near the second edge 109 of the first portion 106 following the general contour of the shell 102 at the second edge 109.

In some embodiments, the second portion 108 includes one or more second inserts 104e and 104f. The one or more second inserts 104e and 104f can be embedded near a second edge 113 of the second portion 108 that is opposite of the first edge 111 of the second portion 108. The second edge 113 of the second portion 108 can be close to a chin of a user during use. The insert 104e can be connected to the insert 104f at a middle portion of the insert 104f such that the one or more second inserts 104e and 104f span a larger area around the second edge 113 of the second portion 108. The one or more second inserts 104e-f can have a smaller thickness than the first inserts 104c and 104d to allow flexibility of a user's jaw motions during use of the respiratory protection device 100.

In some embodiments, the first portion 106 of the respiratory protection device 100 can further include a wire 112 embedded in the first portion 106 around the groove 110. The wire 112 can be made of a metal (e.g., aluminum, titanium, silver, nickel, or any alloy thereof, or any combination thereof). The wire 212 can be flexible and bendable to conform to the shape of a user's nose area, such that a tighter seal can be formed around the nose and nose bridge areas of the user during use of the respiratory protection device 200.

In some embodiments, the respiratory protection device 100 includes a filter medium 114 including a filter material 116. In some embodiments, the filter medium 114 can further include an edge (not shown) surrounding the filter material 116 and defining a perimeter around the filter material 116. In some embodiments, the edge of the filter medium 114 is configured to be inserted into a groove included inside a receiving frame 118 of the shell 102. In some embodiments, the edge of the filter medium 114 is formed of a different material than the filter material 116. In some embodiments, the edge of the filter medium 114 is formed of the same material as the filter material 116. In some embodiments, the edge of the filter medium 114 is formed of a material more rigid than the filter material 116. In some embodiments, the edge of the filter medium 114 is formed of a material more rigid than the shell 102.

In some embodiments, the filter medium 114 is formed of an elastomeric material surrounding a filter material 116. In some embodiments, the filter material 116 forms a pleated surface. The pleated surface can include a plurality of vertical or horizontal pleats. In some embodiments, the edge of the filter medium 114 formed of an elastomeric material can help retain the shape of the pleated surface formed by the filter material 116. The elastomeric material can include, for example, natural rubber, polyurethane, polybutadiene, neoprene, silicone, or a combination thereof. The filter material 116 can include polypropylene, polyester, glass microfibers, cellulose, or a combination thereof.

In some embodiments, the shell 102 is made of a material less rigid than the elastomeric material of the filter medium 114. In some embodiments, the edge of the filter medium 114 is formed of a rigid elastomeric material that can be inserted into the shell 102. In some embodiments, the edge of the filter medium 114 is formed of a semi-rigid elastomeric material and can be compressed and thus easily fit into the shell 102 formed of a rigid or semi-rigid material. In some embodiments, the edge of the filter medium 114 includes a rigid elastomeric material having a Shore D hardness from a range of 70 to 120, or 70 to 110, or 70 to 100, or 70 to 90, or 70 to 80, or can have a Shore D hardness encompassed within these ranges. In some embodiments, the edge of the filter medium 114 includes a rigid elastomeric material having a Shore D hardness from a range of 75 to 120, or 80 to 120, or 90 to 120, or 100 to 120, or 110 to 120, or can have a Shore D hardness encompassed within these ranges.

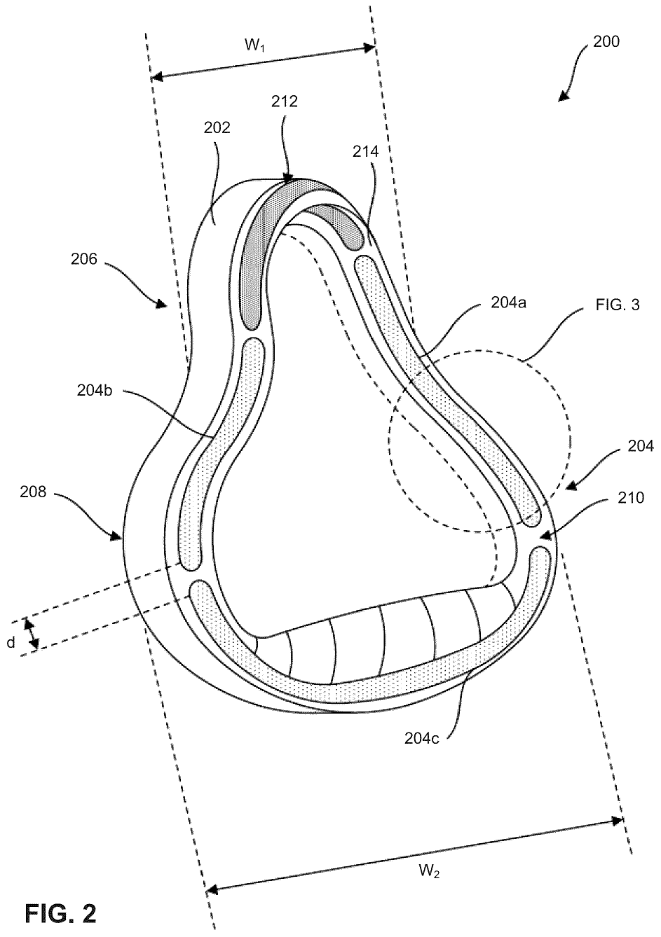

FIGS. 2 to 4 illustrate different parts of an example respiratory protection device 200 (which can be the device 100 shown in FIG. 1), in accordance with some embodiments of the present disclosure.

As shown, the respiratory protection device 200 (which can be, be a part of, or include a respirator) includes a shell 202 shaped to cover at least a portion of a face of a user (such as to cover the mouth or the external nares of a human user, or a combination thereof) and one or more inserts 204 embedded in the shell 202. In some embodiments, the one or more inserts 204 are formed of a thermoformable material moldable at a temperature safe to contact a skin of the user.

In some embodiments, the shell 202 is made of a rigid or semi-rigid material. The rigid material can include acrylonitrile butadiene styrene, nylon, polycarbonate, polyethylene, or polypropylene, or a combination thereof. The semi-rigid material can include silicone or polyurethane, or a combination thereof.

In some embodiments, the one or more inserts 204 are capable of being heated to a moldable temperature of the thermoformable material, and form-fitted to at least a portion of the face such that the shell creates a seal around the portion of the face of the user (such as to create a seal around the mouth or the external nares of a human user, or a combination thereof). The thermoformable material can include a thermoplastic polymer, for example, polypropylene (PP), thermoplastic polyurethane (TPU), polycaprolactone (PCL), ethylene-vinyl acetate (EVA), polypropylene carbonate (PPC), poly(tetramethylene oxide) (PTMO), poly(ethylene adipate) (PEA), poly(ethylene oxide) (PEO), polyethylene glycol (PEG), poly(tetramethylene oxide) (PTMO), a copolymer thereof, or a combination thereof.

In some embodiments, the thermoformable material is moldable at a temperature from a range of 30° C. to 70° C., or 30° C. to 65° C., or 30° C. to 60° C., or 30° C. to 55° C., or 30° C. to 50° C., or 30° C. to 45° C., or 30° C. to 40° C., or 30° C. to 35° C., or can be moldable at a temperature encompassed within these ranges.

In some embodiments, the thermoformable material is moldable at a temperature from a range of 30° C. to 70° C., or 35° C. to 70° C., or 40° C. to 70° C., or 45° C. to 70° C., or 50° C. to 70° C., or 55° C. to 70° C., or 60° C. to 70° C., or 65° C. to 70° C., or can be moldable at a temperature encompassed within these ranges.

In some embodiments, the thermoformable material includes low-temperature thermoplastics, for example, polycaprolactone or ethylene-vinyl acetate. In some embodiments, the thermoformable material has a Young's modulus from a range of 0.03 GPa to 1 GPa at temperatures less than 30° C. In some embodiments, the thermoformable material has a Young's modulus from a range of 0.04 GPa to 1 GPa, or 0.05 GPa to 1 GPa, or 0.06 GPa to 1 GPa, or 0.07 GPa to 1 GPa, or 0.08 GPa to 1 GPa, or 0.09 GPa to 1 GPa, or 0.1 GPa to 1 GPa, or 0.2 GPa to 1 GPa, or 0.3 GPa to 1 GPa, or 0.4 GPa to 1 GPa, or 0.5 GPa to 1 GPa, or 0.6 GPa to 1 GPa, or 0.7 GPa to 1 GPa, or 0.8 GPa to 1 GPa, or 0.9 GPa to 1 GPa at temperatures of less than 30° C., or can have a Young's modulus at a temperature less than 30° C. encompassed within these ranges.

In some embodiments, the thermoformable material has a Young's modulus from a range of 0.03 GPa to 0.9 GPa, or 0.03 GPa to 0.8 GPa, or 0.03 GPa to 0.7 GPa, or 0.03 GPa to 0.6 GPa, or 0.03 GPa to 0.5 GPa, or 0.03 GPa to 0.4 GPa, or 0.03 GPa to 0.3 GPa, or 0.03 GPa to 0.2 GPa, or 0.03 GPa to 0.1 GPa at temperatures of less than 30° C., or can have a Young's modulus at a temperature less than 30° C. encompassed within these ranges.

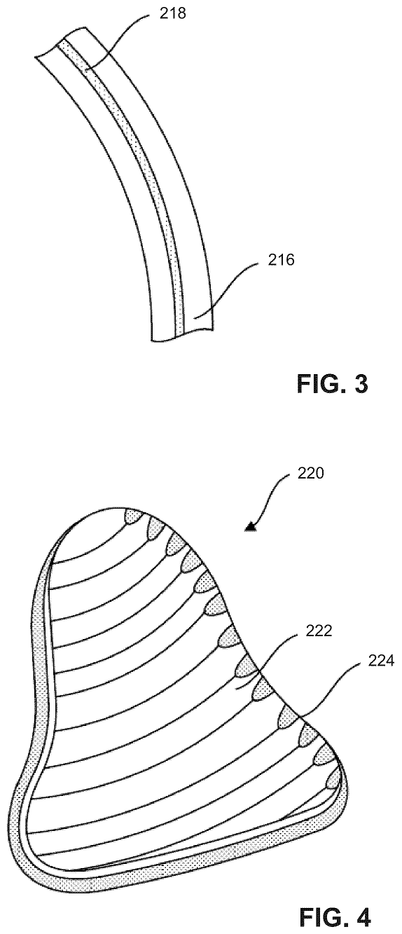

In some embodiments, the user's face includes a nose and a mouth, and the respiratory protection device 200 can include a first portion 206 configured to cover the nose of the user (or at least the nostrils of the user) and a second portion 208 configured to cover the mouth of the user. In some embodiments, the first portion has a first average width (w1), and the second portion has a second average width (w2). In some embodiments, the first average width (w1) is the same as the second average width (w2). In some embodiments, for example as shown in FIG. 3, the first average width (w1) is the smaller than the second average width (w2).

In some embodiments, the one or more inserts 204 includes first inserts 204a and 204b. The first inserts 204a and 204b can be embedded in both the first portion 206 and the second portion 208 of the respiratory protection device 200. In some embodiments, the first inserts 204a and 204b have a first thickness from a range of 0.5 mm to 8 mm, or 1 mm to 8 mm, or 2 mm to 8 mm, or 3 mm to 8 mm, or 4 mm to 8 mm, or 5 mm to 8 mm, or 6 mm to 8 mm, or 7 mm to 8 mm, or can have a first thickness encompassed within these ranges.

In some embodiments, the first inserts 204a and 204b have a first thickness from a range of 0.5 mm to 7 mm, or 0.5 mm to 6 mm, or 0.5 mm to 5 mm, or 0.5 mm to 4 mm, or 0.5 mm to 3 mm, or 0.5 mm to 2 mm, or 0.5 mm to 1 mm, or can have a first thickness encompassed within these ranges.

In some embodiments, the one or more inserts 204 includes a second insert 204c embedded in only the second portion of the shell. In some embodiments, the second insert 204c has a second thickness from a range of 0.1 mm to 3 mm, or 0.1 mm to 2.5 mm, or 0.1 mm to 2 mm, or 0.1 mm to 1.5 mm, or 0.1 mm to 1 mm, or 0.1 mm to 0.9 mm, or 0.1 mm to 0.8 mm, or 0.1 mm to 0.7 mm, or 0.1 mm to 0.6 mm, or 0.1 mm to 0.5 mm, or 0.1 mm to 0.4 mm, or 0.1 mm to 0.3 mm, or 0.1 mm to 0.2 mm, or can have a second thickness encompassed within these ranges.

In some embodiments, the second thickness of the second insert 204c can be smaller than the first thickness of the first inserts 204a and 204b to allow flexibility of a user's jaw motion during use of the respiratory protection device 200.

In some embodiments, the first inserts 204a and 204b and the second insert 204c can be connected or are abutting. In some embodiments, the shell 202 can include a gap 210 in between the first inserts 204a and 204b and the second insert 204c to allow flexibility of a user's jaw motion during use of the respiratory protection device 200. In some embodiments, the first inserts 204a and 204b are spaced apart from the second insert 204c at a distance (d) from a range of 1 mm to 35 mm.

In some embodiments, the first portion 206 of the respiratory protection device 200 can further include a wire 212 embedded in the first portion 206. The wire 212 can be made of a metal (e.g., aluminum, titanium, silver, nickel, or any alloy thereof, or any combination thereof). The wire 212 can be flexible and bendable to conform to the shape of a user's nose area during use of the respiratory protection device 200.

In some embodiments, the shell 202 has a first side 214 as shown in FIG. 2. The first side 214 can directly contact a user's face during use of the respiratory protection device 200. In some embodiments, the one or more inserts 204 are embedded in the first side 214 of the shell 202.

In some embodiments, the shell 202 has a second side 216 opposite of the first side 214 of the shell. In some embodiments, for example as shown in FIG. 3, the second side 216 includes a groove 218 (e.g., a cut channel).

In some embodiments, the respiratory protection device 200 includes a filter medium 220 including a filter material 222. In some embodiments, for example as shown in FIG. 4, the filter material 222 is surrounded by an edge 224 defining a perimeter around the filter material 222 and configured to be inserted into the groove 218 on the second side 216 of the shell 202. As the filter medium 220 is removable from the groove 218 by sliding in and out, the shell 202 is reusable should the user choose to change to a different piece of filter after a period of use.

In some embodiments, the edge 224 of the filter medium 220 is formed of a different material than the filter material 222. In some embodiments, the edge 224 is formed of the same material as the filter material 222. In some embodiments, the edge 224 is formed of a material more rigid than the filter material 222. In some embodiments, the edge 224 of the filter medium 220 is formed of an elastomeric material having Shore D hardness from a range of 70 to 120, or 70 to 110, or 70 to 100, or 70 to 90, or 70 to 80, or can have a Shore D hardness encompassed within these ranges. In some embodiments, the edge of the filter medium 114 includes a rigid elastomeric material having a Shore D hardness from a range of 75 to 120, or 80 to 120, or 90 to 120, or 100 to 120, or 110 to 120, or can have a Shore D hardness encompassed within these ranges.

In some embodiments, the edge 224 surrounds the filter material 222 forming a pleated surface. In some embodiments, for example as shown in FIG. 4, the pleated surface can include a plurality of horizontal pleats. In some embodiments, the pleated surface can include a plurality of vertical pleats. The elastomeric material of the edge 224 can include, for example, natural rubber, polyurethane, polybutadiene, neoprene, silicone, or a combination thereof. The filter material 222 can include polypropylene, polyester, glass microfibers, cellulose, or a combination thereof.

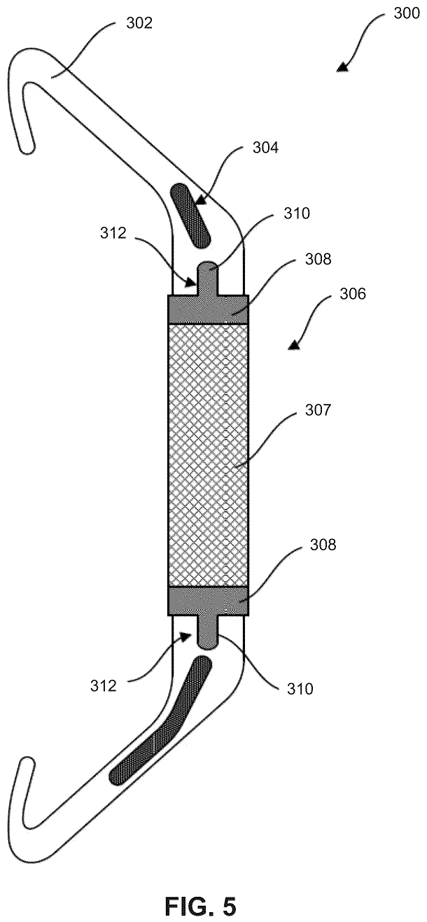

FIG. 5 illustrates is a cross-sectional view of an example respiratory protection device 300, such as the device shown in FIG. 1, in accordance with some embodiments of the present disclosure. As shown, the respiratory protection device 300 includes a shell 302 configured to form a seal around a user's face (such as to form a seal around the mouth or the external nares of a human user, or a combination thereof). In some embodiments, the shell 302 can have one or more inserts 304 formed of a thermoformable material. In some embodiments, the one or more inserts 304 are embedded in the shell 302 such that the shell 302 is compliant to the variable topography of a user's face. In some embodiments, the thermoformable material is moldable at a temperature safe to contact a skin of the user.

In some embodiments, the one or more inserts 304 are capable of being heated to a moldable temperature of the thermoformable material, and form-fitted to at least a portion of the face such that the shell creates a seal around the portion of the face of the user (such as to cover the mouth or the external nares of a human user, or a combination thereof). The thermoformable material can include a thermoplastic polymer, for example, polypropylene (PP), thermoplastic polyurethane (TPU), polycaprolactone (PCL), ethylene-vinyl acetate (EVA), polypropylene carbonate (PPC), poly(tetramethylene oxide) (PTMO), poly(ethylene adipate) (PEA), poly(ethylene oxide) (PEO), polyethylene glycol (PEG), poly(tetramethylene oxide) (PTMO), a copolymer thereof, or a combination thereof.

In some embodiments, the thermoformable material is moldable at a temperature from a range of 30° C. to 70° C., or 30° C. to 65° C., or 30° C. to 60° C., or 30° C. to 55° C., or 30° C. to 50° C., or 30° C. to 45° C., or 30° C. to 40° C., or 30° C. to 35° C., or can be moldable at a temperature encompassed within these ranges.

In some embodiments, the thermoformable material is moldable at a temperature from a range of 30° C. to 70° C., or 35° C. to 70° C., or 40° C. to 70° C., or 45° C. to 70° C., or 50° C. to 70° C., or 55° C. to 70° C., or 60° C. to 70° C., or 65° C. to 70° C., or can be moldable at a temperature encompassed within these ranges.

In some embodiments, the respiratory protection device 300 further includes a filter medium 306. The filter medium 306 can include a filter material 307 surrounded by an edge 308 defining a perimeter around the filter material 307. In some embodiments, the edge 308 include potted ends 310 configured to be inserted into grooves 312 of the shell 302. As the filter medium 306 is removable from the grooves 312 by sliding in and out, the shell 302 is reusable.

In some embodiments, the edge 308 of the filter medium 306 is formed of a different material than the filter material 307. In some embodiments, the edge 308 is formed of the same material as the filter material 307. In some embodiments, the edge 308 is formed of a material more rigid than the filter material 307. In some embodiments, the filter material 307 forms a pleated surface. The pleated surface can include a plurality of vertical or horizontal pleats. In some embodiments, the edge 308 helps retain the shape of the pleated surface formed by the filter material.

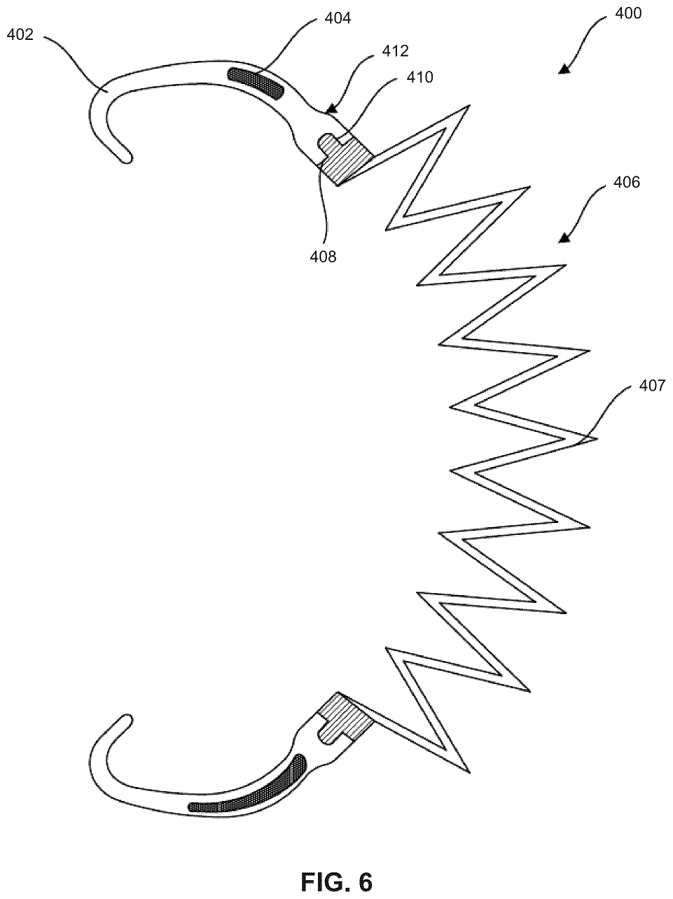

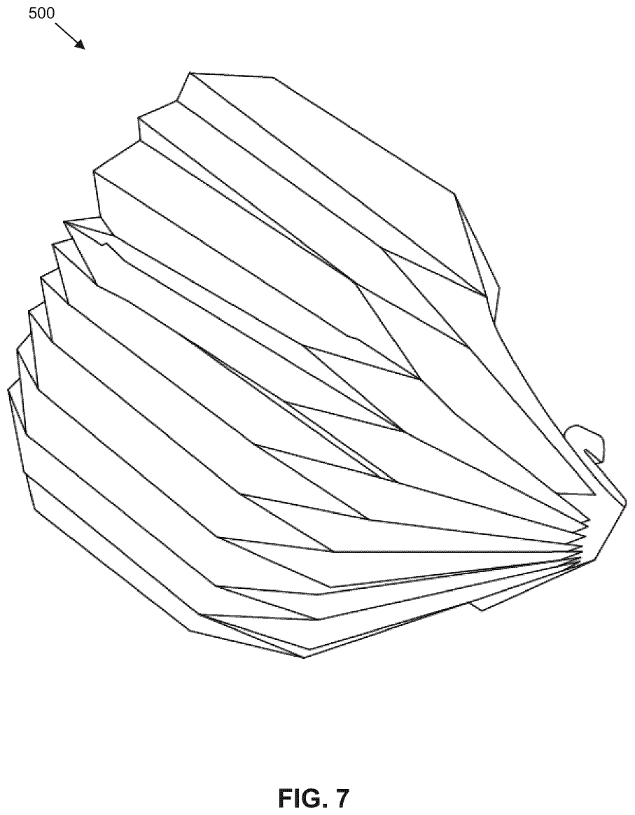

FIG. 6 illustrates a cross-sectional view of an example respiratory protection device 400 having a filter medium 406, in accordance with some embodiments of the present disclosure. FIG. 7 illustrates a perspective view of an example filter medium 500, such as for the device shown in FIG. 6, in accordance with an embodiment of the present disclosure.

As shown, the respiratory protection device 400 includes a shell 402 configured to form a seal around a user's face (such as to provide a seal around the mouth or the external nares of a human user, or a combination thereof). The shell 402 can have one or more inserts 404 formed of a thermoformable material embedded in the shell 402 such that the shell 402 is compliant to the variable topography of a user's face. In some embodiments, the thermoformable material is moldable at a temperature safe to contact the skin of the user.

In some embodiments, the respiratory protection device 400 further includes a filter medium 406. The filter medium 406 can include a filter medium body 407 surrounded by an edge 408 defining a perimeter around the filter medium body 407. In some embodiments, the edge 408 include potted ends 410 configured to be inserted into grooves 412 of the shell 402. As the filter medium 406 is removable from the grooves 412 by sliding in and out, the shell 402 is reusable.

In some embodiments, the edge 408 of the filter medium 406 is formed of a different material than the filter medium body 407. In some embodiments, the edge 408 is formed of the same material as the filter medium body 407. In some embodiments, the edge 408 is formed of a material more rigid than the filter medium body 407. In some embodiments, for example as shown in FIG. 7 as the filter medium 500, the filter medium 406 or filter medium 500 is formed of a laminated material foldable into an “origami” style. In some embodiments, the edge 408 and filter medium body 407 are both made of a laminated material.

In some embodiments, the laminated material can include a semi-rigid support material laminated with a filter material. In some instances, the semi-rigid support material includes silicone, polypropylene, polyester, or polyurethane, or a combination thereof. In some instances, the filter material includes polypropylene, polyester, glass microfibers, or cellulose, or a combination thereof. In some embodiments, the laminated material includes two layers. In some embodiments, the laminated material including more than two layers. In some embodiments, the laminated material includes a first layer formed of a semi-rigid support material, a second layer formed of a filter material, and a third layer in the middle of the first and second layer. In some embodiments, the third middle layer is formed of materials including natural rubber, polyurethane, polybutadiene, neoprene, silicone, or a combination thereof.

In some embodiments, the laminated material includes a melt-blown filter material (e.g., polypropylene) laminated to a semi-rigid support material (e.g., polyethylene). In some instances, the semi-rigid support material forms a sheet including one or more perforations before lamination.

In some embodiments, a method of making a respiratory protection device includes laminating a filter material to a semi-rigid support material to form a laminated material, folding the laminated material to form a filter medium, and inserting the filter medium into a reusable shell. In some embodiments, the laminated material is folded into an origami style (e.g., as shown in FIG. 7). In some embodiments, the filter medium includes an edge with potted ends configured to be inserted into grooves of the shell.

While the invention has been described in conjunction with the specific embodiments described herein, it is evident that many alternatives, combinations, modifications, and variations are apparent to those skilled in the art. Accordingly, the example embodiments of the invention, as set forth herein are intended to be illustrative only, and not in a limiting sense. Various changes can be made without departing from the spirit and scope of the invention.

What is claimed is:

1. An apparatus, comprising:
a shell of a respiratory protection device shaped to cover at least the mouth or the external nares of a human user; and
one or more inserts embedded in a first side of the shell,
wherein the one or more inserts are formed of a thermoformable material, and
wherein the one or more inserts are capable of being heated to a moldable temperature of the thermoformable material and form-fitted to at least a portion of the face of the human user such that the shell creates a seal around at least the mouth or the external nares of the human user.

2. The apparatus of claim 1, wherein the shell is made of a rigid material, and wherein the rigid material comprises acrylonitrile butadiene styrene, nylon, polycarbonate, polyethylene, polypropylene, or a combination thereof.

3. The apparatus of claim 1, wherein the shell is made of a semi-rigid material, and wherein the semi-rigid material comprises silicone, polyurethane, or a combination thereof.

4. The apparatus of claim 1, wherein the thermoformable material comprises a thermoplastic polymer.

5. The apparatus of claim 1, wherein the thermoformable material comprises a low-temperature thermoplastic comprising polycaprolactone (PCL), ethylene-vinyl acetate (EVA), thermoplastic polyurethane (TPU), or a combination thereof.

6. The apparatus of claim 1, wherein the shell comprises a first portion configured to cover the external nares of the human user and a second portion configured to cover the mouth of the human user, and wherein the first portion has a first width and the second portion has a second width.

7. The apparatus of claim 6, wherein the first width is same as the second width.

8. The apparatus of claim 6, wherein the one or more inserts comprise one or more first inserts, and wherein each of the one or more first inserts is embedded in the first and the second portions of the shell.

9. The apparatus of claim 8, wherein the one or more inserts comprise a second insert embedded in only the second portion of the shell.

10. The apparatus of claim 9, wherein the one or more first inserts and the second insert are abutting.

11. The apparatus of claim 9, wherein the one or more first inserts and the second insert are connected.

12. The apparatus of claim 9, wherein the one or more first inserts are spaced apart from the second insert.

13. The apparatus of claim 6, wherein the shell further comprises a metal wire embedded in the first portion.

14. The apparatus of claim 1, wherein the thermoformable material is moldable at a temperature safe to contact the skin of the human user.

15. The apparatus of claim 1, wherein the thermoformable material has a Young's modulus from a range of 0.03 GPa to 1 GPa at temperatures of less than 30° C.

16. The apparatus of claim 1, wherein the shell has a groove formed on a second side of the shell opposite of the first side of the shell, and wherein the apparatus further comprises a filter medium, the filter medium comprising:
a filter material; and
an edge defining a perimeter around the filter material,
wherein the edge is configured to be inserted into the groove on the second side of the shell.

17. An apparatus, comprising:
a shell of a respiratory protection device shaped to cover at least the mouth or the external nares of a human user;
one or more inserts embedded in a first side of the shell, wherein the one or more inserts are formed of a thermoformable material; and
a filter medium, the filter medium comprising: a filter material; and
an edge defining a perimeter around the filter material, wherein the filter medium is configured to attach to a second side of the shell opposite of the first side of the shell.

18. The apparatus of claim 17, wherein the edge of the filter medium is configured to be inserted into a groove on the second side of the shell.

19. An apparatus, comprising:
a shell of a respiratory protection device shaped to cover at least the mouth or the external nares of a human user;
one or more inserts embedded in a first side of the shell; and
a filter medium, the filter medium comprising: a filter material; and
an edge defining a perimeter around the filter material,
wherein the one or more inserts are formed of a thermoformable material,
wherein the one or more inserts are capable of being heated to a moldable temperature of the thermoformable material and form-fitted to at least a portion of the face of the human user such that the shell creates a seal around at least the mouth or the external nares of the human user.

20. The apparatus of claim 19, wherein the filter medium is configured to attach to a second side of the shell opposite of the first side of the shell.
